(19) United States
(12) Patent Application Publication
(10) Pub. No.: US 2007/0257547 A1
(43) Pub. Date: Nov. 8, 2007

(54) Wheel Rim Assembly and Method for Making the Same

(75) Inventor: Wang-Fa Tsai, Changhua Hsien (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: YUAN FENG INDUSTRIAL CO., LTD., HSIEN-HSI HSIANG CHANG HUA HSIEN (TW)

(21) Appl. No.: 11/381,350

(22) Filed: May 2, 2006

(51) Int. Cl. B60B 7/00

(52) U.S. Cl. 301/37.11

(57) ABSTRACT

A wheel rim assembly includes a wheel rim, a cover, and a binder. The wheel rim includes a rim portion having two axially opposite end rings, and a disk portion having a plurality of radially extending spokes connected to one of the end rings. The cover covers the one of the end rings and the disk portion, and has a plating layer formed thereon opposite to the disk portion of the wheel rim. The binder bonds the cover to the wheel rim.

### BACKGROUND OF THE INVENTION

1. Field of the Invention

The invention relates to a wheel rim assembly, more particularly to a wheel rim assembly for a motorcycle or an automobile. This invention also relates to a method for making the wheel rim assembly.

2. Description of the Related Art

A conventional wheel rim is made by integrally casting or punching followed by a sequence of processing steps, such as grinding, polishing, washing, degreasing, baking, and Cr-free plating (or anodizing).

However, since the conventional wheel rim is made integrally and is formed with a complicated configuration having a plurality of protrusions and recesses, the conventional wheel rim is liable to be damaged due to collision during the processing steps or during packing and shipping. The damaged wheel rim should be disposed of due to its integral configuration, which in turn increases production cost. Furthermore, the design for the conventional wheel rim is devoid of flexibility due to the limitation of its integral configuration.

A cover was developed in the art to cover the wheel rim in order to change the appearance of the wheel rim. Since the cover is usually fastened to the wheel rim by anchoring, it is likely to be detached from the wheel rim in use, especially when the motorcycle or the automobile using the wheel rim is running.

### SUMMARY OF THE INVENTION

The object of the present invention is to provide a wheel rim assembly, which is flexible in design, and which can be produced relatively simply and easily.

Accordingly, in one aspect of this invention, a wheel rim assembly includes a wheel rim, a cover, and a binder. The wheel rim includes a rim portion having two axially opposite end rings, and a disk portion having a plurality of radially extending spokes connected to one of the end rings. The cover covers said one of the end rings and the disk portion, and has a plating layer formed thereon opposite to the disk portion of the wheel rim. The binder bonds the cover to said one of the end rings and the disk portion.

In another aspect of this invention, a method for making a wheel rim assembly includes the steps of:

preparing a wheel rim including a rim portion, and a disk portion having a plurality of spokes extending radially and connected to said rim portion;

preparing a cover including an outer plating layer; and

adhering the cover to the disk portion of the wheel rim by using a binder so that the disk portion is covered by the cover.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the preferred embodiment of a wheel rim assembly according to this invention;

FIG. 2 is a perspective view of the preferred embodiment in an assembled state;

FIG. 3 is a fragmentary sectional view taken along line 3-3 in FIG. 2; and

FIG. 4 is a flowchart of the preferred embodiment of a method for making a wheel rim assembly according to this invention.

### DETAILED DESCRIPTION OF THE PREFERRED EMBODIMENTS

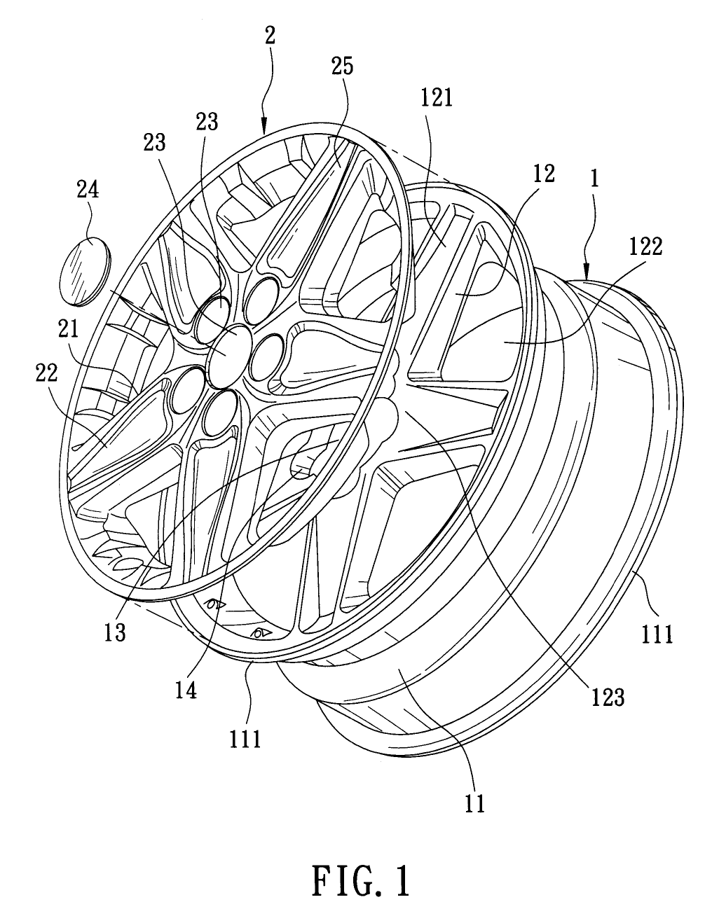

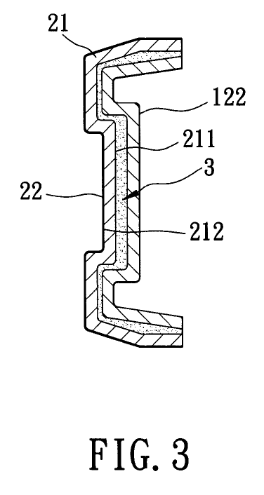

Referring to FIGS. 1, 2, and 3, the preferred embodiment of a wheel rim assembly according to this invention includes a wheel rim 1, a cover 2, and a binder 3.

The wheel rim 1 includes a rim portion 11 having two axially opposite end rings 111, and a disk portion 12 having a plurality of radially extending first spokes 121 connected to one of the end rings 111. In this preferred embodiment, the disk portion 12 is formed integrally with the rim portion 11. The disk portion 12 of the wheel rim 1 further includes a central part 123 from which the first spokes 121 extend, a central hole 13 formed in the central part 123, and a plurality of fixing holes 14 formed in the central part 123 around the central hole 13. Two adjacent ones of the first spokes 121 define a void space 122.

The cover 2 covers the one of the end rings 111 and the disk portion 12, and includes a cover body 21 and a plating layer 22 (a Cr-free plating layer) formed thereon opposite to the disk portion 12 of the wheel rim 1. In this preferred embodiment, the cover body 21 is made of a plastic material. The cover 2 further includes a plurality of through holes 23 corresponding to the central hole 13 and the fixing holes 14, respectively, a plurality of second spokes 25 corresponding to the first spokes 121, and a covering plate 24 covering one of the through holes 23 corresponding to the central hole 13. The cover 2 further includes an inner surface 211 shaped to interfit complementarily with surfaces of the one of the end rings 111 and the disk portion 12, and an outer surface 212 which can be varied as desired.

The binder 3 is filled between the disk portion 12 of the wheel rim 1 and the cover 2 so as to bond the cover 2 to the one of the end rings 111 and the disk portion 12.

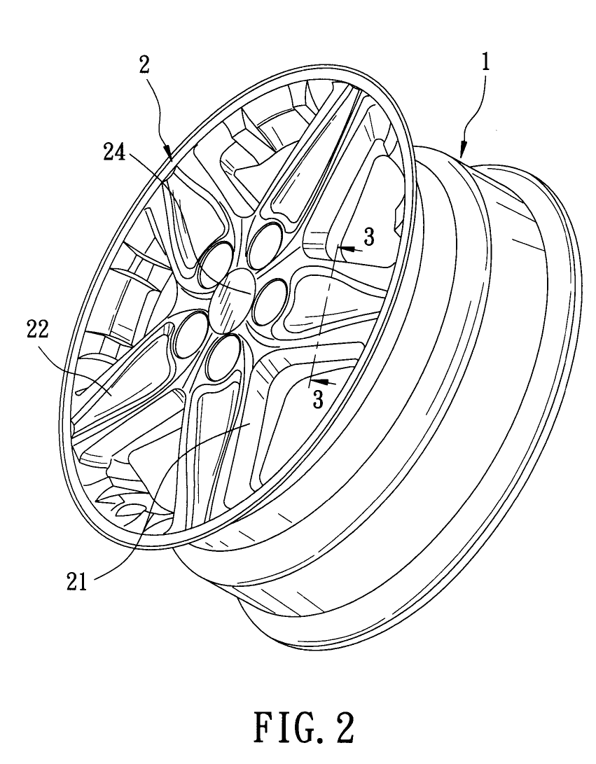

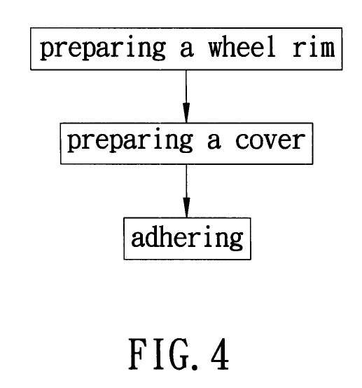

Referring to FIGS. 2, 3, and 4, the preferred embodiment of a method for making the wheel rim assembly according to this invention includes the steps of:

1) preparing the wheel rim 1:

The wheel rim 1 is made by casting or by punching. The processing steps, such as grinding, polishing, washing, degreasing, etc., required in the prior art are not necessary for the wheel rim 1.

2) preparing the cover 2:

The cover body 21 is made of a thermosetting plastic material. The plating layer 22 is plated on the outer surface 212 of the cover body 21 under vacuum so as to obtain the cover 2. The shape, the color and the luster of the outer surface 212 can be varied as desired. A further processing step can be performed on the outer surface 212 so as to enhance the hardness of the cover 2.

3) adhering:

The cover 2 is adhered to the disk portion 12 of the wheel rim 1 by using the binder 3 so that the disk portion 12 is covered by the cover 2. The adhering can be conducted by applying the binder 3 on the first spokes 121 and the one of the end rings 111 and then mounting the cover 2 onto the disk portion 12 of the wheel rim 1, or by disposing the cover 2 on the disk portion 12 of the wheel rim 1 and then filling the binder 3 between the cover 2 and the disk portion 12 of the wheel rim 1.

In view of the aforesaid, the wheel rim assembly of this invention has the following advantages:

1. The cover 2 can be made separately from the wheel rim 1, and can be varied in its design, such as the shape, the color, and the like, according to specific requirements. The problem of disposing of the damaged integral wheel rim encountered in the prior art can be avoided, and the cover 2 can be made flexibly.

2. It is not necessary to further treat the wheel rim 1 by grinding, polishing, washing, degreasing, etc., which are required in the prior art. Furthermore, when the cover 2 is damaged or when the user wants to change the appearance of the cover 2, it is only necessary to replace the damaged or old cover 2 with a new one. Therefore, the production cost can be reduced.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A wheel rim assembly, comprising:
a wheel rim including a rim portion having two axially opposite end rings, and a disk portion having a plurality of radially extending first spokes connected to one of said end rings;
a cover covering said one of said end rings and said disk portion, and having a plating layer formed thereon opposite to said disk portion of said wheel rim; and
a binder bonding said cover to said one of said end rings and said disk portion.

2. The wheel rim assembly as claimed in claim 1, wherein said cover further includes an inner surface shaped to interfit complementarily with surfaces of said one of said end rings and said disk portion.

3. The wheel rim assembly as claimed in claim 1, wherein said disk portion of said wheel rim further includes a central part from which said first spokes extend, a central hole formed in said central part, and a plurality of fixing holes formed in said central part around said central hole.

4. The wheel rim assembly as claimed in claim 3, wherein said cover further includes a plurality of through holes corresponding to said central hole and said fixing holes, respectively, and a plurality of second spokes corresponding to said first spokes.

5. The wheel rim assembly as claimed in claim 1, wherein said cover includes a plastic material.

6. A method for making a wheel rim assembly, comprising the steps of:
preparing a wheel rim including a rim portion, and a disk portion having a plurality of spokes extending radially and connected to said rim portion;
preparing a cover including an outer plating layer; and
adhering the cover to the disk portion of the wheel rim by using a binder so that the disk portion is covered by the cover.
